(19) United States
(12) Patent Application Publication
(10) Pub. No.: US 2015/0165341 A1
(43) Pub. Date: Jun. 18, 2015

(54) SEPARATOR CARTRIDGE FOR RADIONUCLIDE

(71) Applicant: NorthStar Medical Radioisotopes LLC, Madison, WI (US)

(72) Inventor: Glenn H. Isensee, Madison, WI (US)

(73) Assignee: NorthStar Medical Radionuclides LLC

(21) Appl. No.: 14/528,789

(22) Filed: Oct. 30, 2014

Related U.S. Application Data
(60) Provisional application No. 61/897,493, filed on Oct. 30, 2013.

(51) Int. Cl. B01D 15/10

(52) U.S. Cl. CPC B01D 15/10

(57) ABSTRACT

A processing device for a radionuclide including a cartridge assembly including a cartridge and receptacle, the cartridge containing a chromatographic material that captures one of a daughter and parent radionuclide from a mixture of the parent and daughter radionuclide passing longitudinally through the cartridge, the cartridge having respective transverse flanges on opposing ends, the receptacle having a slot on each end of a space that receives the cartridge where, the slots on each end receive the transverse flanges, the receptacle further including a connection assembly on each end of the space, the connection assemblies each having a lever that is moved along a respective slot that advances a connector towards the cartridge while twisting the connector as it makes contact with the cartridge to form a liquid tight connection.

### FIELD OF THE INVENTION

The field of the invention relates to nuclear medicine and more particularly, to methods of processing radioactive nuclides.

### BACKGROUND OF THE INVENTION

This Application is a continuation-in-part of U.S. Provisional Patent Application No. 61/897,493 filed on Oct. 30, 2013 (pending).

The use of radioactive materials in nuclear medicine for therapeutic and diagnostic purposes is known. In the case of diagnostic medicine, radioactive material may be used to track blood flow for purposes of detecting obstructions or the like. In this case the radioactive material (e.g., a tracer) may be injected into a vein of the arm or leg of a person.

A scintillation camera may be used to collect images of the person following the injection. In this case, the gamma rays of the tracer interact with a detector of the camera to create images of the person.

A series of images are collected as the tracer perfuses through the person. Since the tracer diffuses through the blood of the person, the veins or arteries with greater blood flow produce a greater signature from the tracer.

Alternatively, radioactive material may be coupled at a molecular level with a biolocalization agent. In this case, the biolocalization agent may concentrate the radioactive material at some specific location (e.g., the site of a tumor).

Key to the use of radioactive materials in nuclear medicine is the creation of nuclear materials with a relatively short half life (e.g., 2-72 hours). In the case of the use of the radioactive materials with a biolocalization agent or for imaging, the short half life causes the radioactivity to decay rapidly in such as way as to reduce exposure of the person to radiation.

While the use of radioactive materials in nuclear medicine is extremely useful, the handling of such materials can be difficult. Materials with short half lives may require complex separation procedures to isolate the desired material from other materials. Once separated, the desired material must be easily accessible. Accordingly, a need exists for better methods of handling such materials.

### BRIEF DESCRIPTION OF THE DRAWINGS

FIG. 1 is a front, perspective view of a device for processing radionuclides shown generally in accordance with an illustrated embodiment of the invention;

FIG. 2 is block diagram of the processing element of the device of FIG. 1;

FIG. 3 is a side perspective view of the separator of FIG. 2;

FIGS. 4A-C are front, side and top views of a separator of FIG. 3;

FIG. 5 is a cut-away view of the separator of FIGS. 4A-C;

FIG. 6 is an exploded view of the separator of FIGS. 3-5 and

FIGS. 7A-B depict a separator assembly where FIG. 7A shows the separator cartridge removed and FIG. 7B shows the separator cartridge in an operating position.

### DETAILED DESCRIPTION OF AN ILLUSTRATED EMBODIMENT

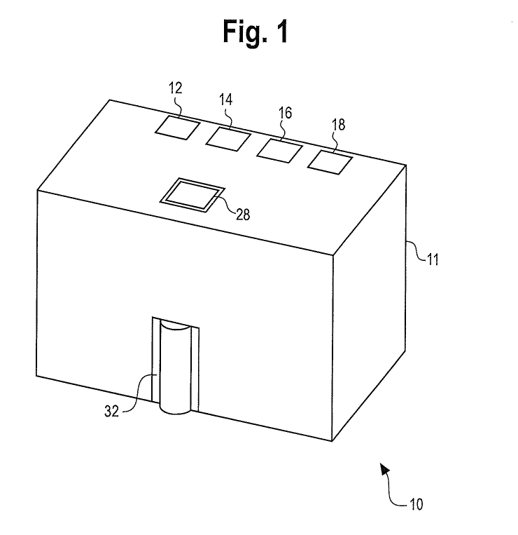

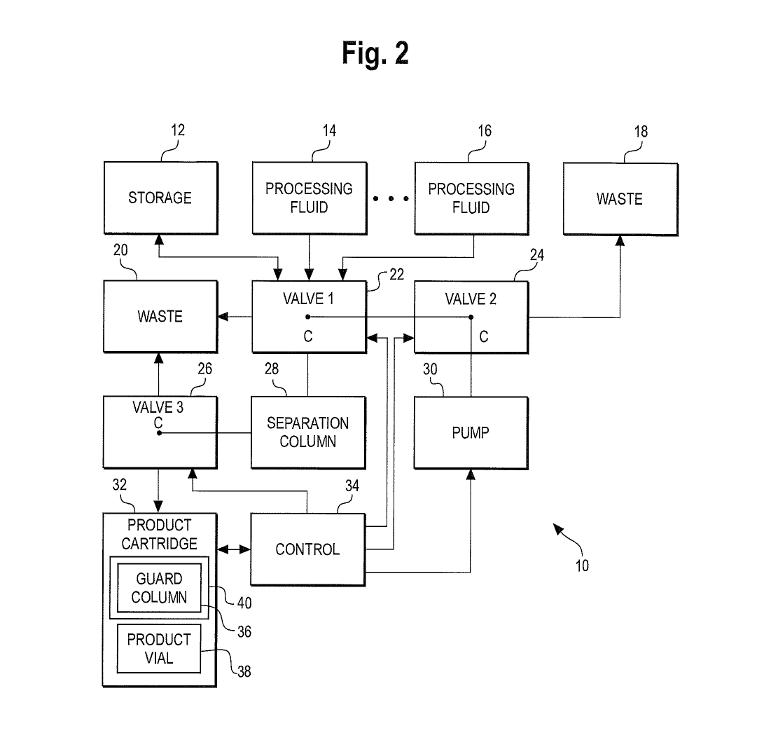

FIG. 1 is a front perspective view of the device and system 10 for processing radionuclides shown generally in accordance with an illustrated embodiment of the invention. FIG. 2 is a block diagram of the separation system 10. The system 10 may be used to provide highly pure radioactive materials for use in diagnostic or therapeutic processes. The system 10 may be constructed as a portable device that is simple to use in radionuclide production facilities, nuclear pharmacies or in some other medical environment.

The system 10 may be used to separate a parent radionuclide from a daughter radionuclide using a forward COW process and where the daughter radionuclide is produced by the decay of the parent radionuclide. The system 10 may also be used to separate a daughter radionuclide from a parent radionuclide using a reverse COW process.

Included within the system 10 may be one or more separation columns 28, 36. The separation column 28 may be selected for purification of a wide range of radionuclides depending upon the diagnostic or therapeutic objectives. For example, the separation columns 26, 36 may be filled within a chromatographic material (e.g., ion-exchange resin, extraction chomotographic material, etc.) targeted for the specific radionuclide needed. In this regard, the system 10 may be used for the purification of yttrium-90, bismuth-212 and 213, or rhenium-188 for radiotherapy or technetium-99 m, thallium-201, fluorine-18 or indium-111 for diagnostic imaging.

In this regard, the system 10 may be provided with a parent radionuclide. After some period of time, some of the parent radionuclide will decay to produce a mixture of parent and daughter radionuclides. In this case, a controller 34 of the system 10 may activate one or more valves 22, 24, 26 and a pump 30 to transport the mixture of the parent and daughter radionuclides from a parent container 12 to a first separation column 28 that captures the daughter radionuclide. Once the mixture of parent and daughter radionuclides has passed through the separation column 28, the remaining parent may be transported back to the parent container 12.

The controller 34 may wash the first separation column 28 by activating valves 22, 24 to first withdraw a wash solution from a processing fluids container 14, 16 and then to discard the wash solution into a waste container 18, 20. The wash process may be repeated any of a number of times with the same or different types of wash solutions.

Once washed, the controller 34 may withdraw a stripping solution from one of the processing fluids containers 14, 16 and then pump the stripping solution through the first separation column 28, through valve 26 and into the product cartridge assembly 32. The stripping solution functions to release the daughter radionuclide from the separator column 28 and then transport the daughter radionuclide into the product cartridge assembly 32.

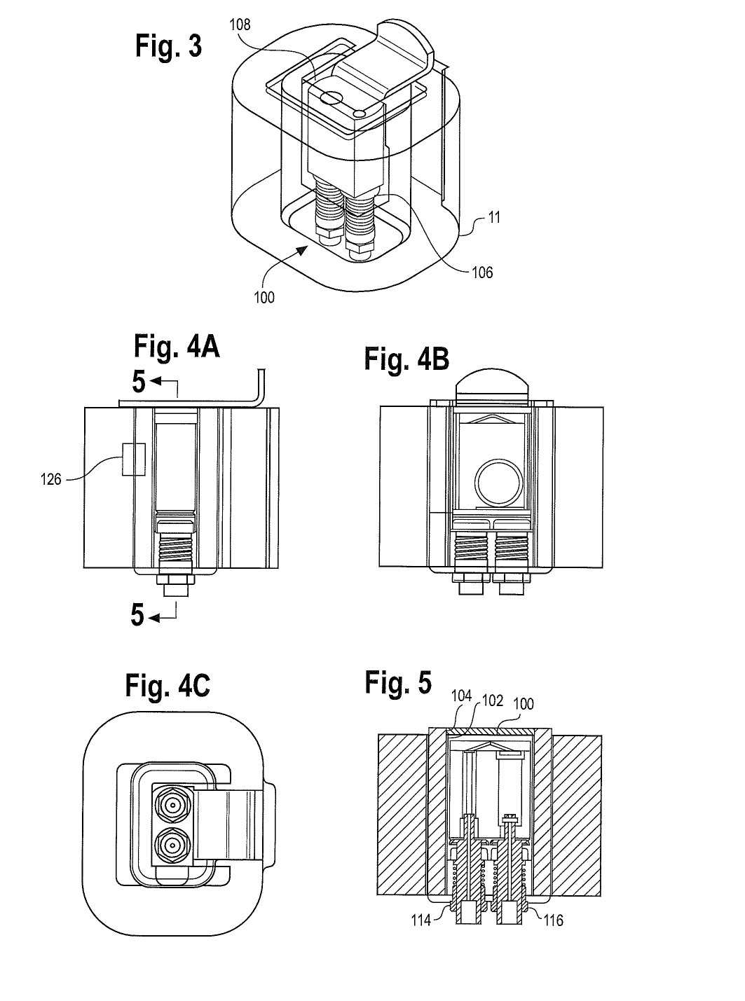

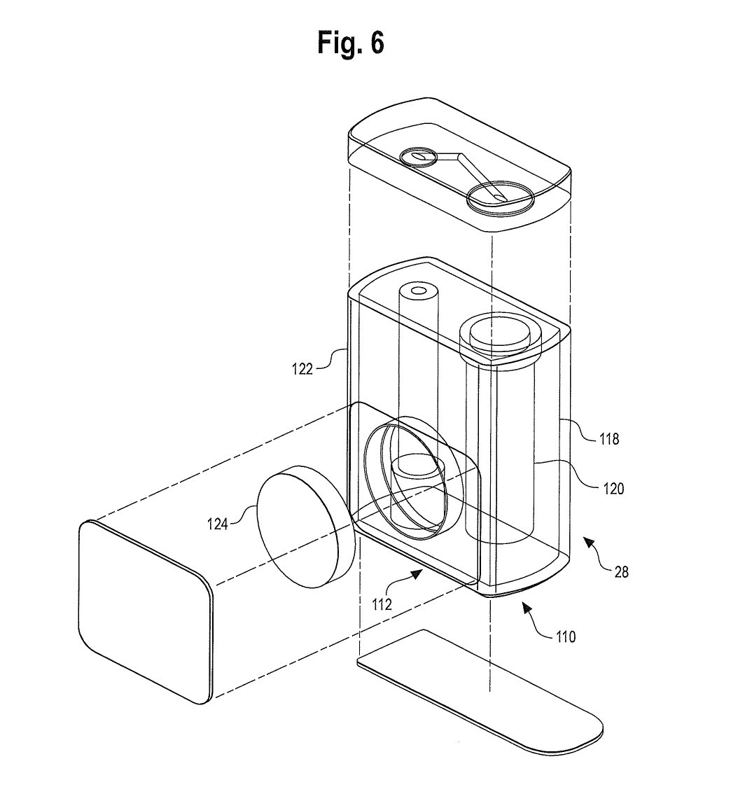

FIG. 3 is a front, perspective view of the separator cartridge 100 including the separator column 28 inserted into a receptacle 102 within the housing 11 of the processing system 10. FIGS. 4A-C are front, right side and top views of the separator cartridge and receptacle of FIG. 3. FIG. 5 is a cut-away view of FIG. 4A. FIG. 6 is an exploded view of the separator column 100.

Since the cartridge 100 is used for processing radionuclides, the cartridge retains at least some radionuclide during use and the cartridge 100 becomes radioactive waste at the end of its useful life. In addition, if the cartridge should leak during use, the leak becomes a hazardous discharge.

The cartridge 100 and receptacle 102 is constructed with unique features to accommodate the hazardous nature of its use. For example, the cartridge 100 and receptacle 102 are constructed with automatic alignment features that operate during insertion of the cartridge 100 into the receptacle 102 and that allows engagement of the respective conduits in a manner that substantially reduces the possibility of leaks.

A pair of parallel Luer fittings may be used to join the conduits on the cartridge 100 and receptacle 102. A first end of the Luer connectors may be provided on an insertion side of the cartridge 100 to allow the cartridge 100 to be inserted and installed into the processing device 10 via a single continuous step. A first of the pair of Luer fitting connects with a first end of an internal chamber containing the separator resin. An internal channel connects a second end of the internal chamber with the second fitting of the pair of Luer fittings. The sides of the cartridge guide the Luer fittings of the cartridge 100 into the Luer fittings of the receptacle 102 to avoid leaks. The cartridge 100 is constructed to fit into a shielded receptacle within the processing device.

In this regard, the receptacle 102 has a bottom end 106 and an open end 108, the bottom end and open end is bounded by a set of mutually parallel walls 104 surrounding the receptacle 102 and where the walls are also parallel to an axis of insertion of the cartridge 100 into the receptacle 102. The bottom of the receptacle has a pair of spring loaded conduit connectors 114, 116 facing the open end with each connector oriented parallel to the axis of insertion.

The separator cartridge 100 is constructed to be inserted into and removed from the receptacle 102 without tools. The separator cartridge 100 includes a housing 122 having a connector end and an opposing end joined by a set of mutually parallel walls extending between the ends and around an outer periphery of the housing. The parallel walls have an outer profile complementary to an inner profile of the parallel walls of the receptacle 102. The cartridge 100 also includes a pair of conduit connectors 110, 112 extending from the housing on the connector end of the cartridge 100 with a spacing and orientation that is complementary to the spring loaded connectors 114, 116 on the bottom end of the receptacle 102 where the insertion of the separator cartridge into the receptacle automatically creates a liquid tight connection between the conduit connectors.

The cartridge 100 includes a chamber 118 within the housing containing a resin 120 that separates a parent from a daughter radionuclide. A first end of the resin chamber 118 is connected to a first connector 110 of the pair of connectors of the housing 122 and a second opposing end of the chamber connected to the second connector 112 of the pair of connectors of the housing 122.

The cartridge 100 contains an embedded Radio Frequency Identifier (RFID) 124. The RFID 124 is read by an RFID reader 126 and controller 34 within the processing device 10 when inserted into the processing device for process integrity. In this regard, the product identifier read from within the RFID 124 is saved to memory as proof of the processing conditions under which the daughter radionuclide was recovered.

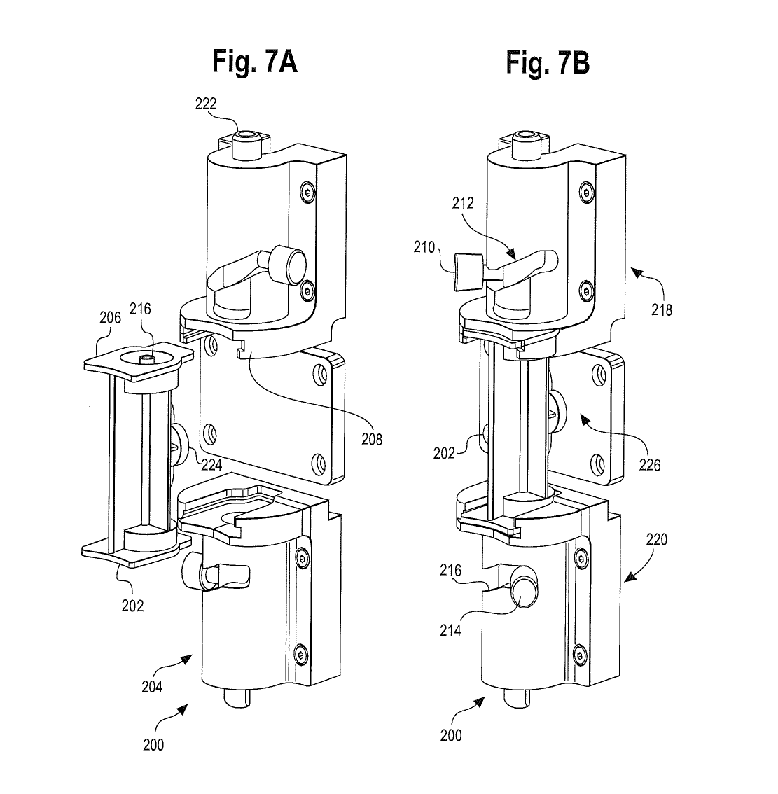

FIGS. 7A-B depicts the separator 28 of FIG. 1 in a context of use in an alternate embodiment. FIGS. 7A-B shows the separator combination 200 including a separator cartridge 202 and cartridge receptacle 204. FIG. 7A shows the cartridge separate from the receptacle and FIG. 7B shows the cartridge inserted into the receptacle in the context of use.

The separator of FIG. 7 is of a flow-through design where fluid enters on one end and exits on the other, opposing end. As shown in FIG. 7, the cartridge has a flange 206 on each end that engages a slot 208 upon insertion into the receptacle. The cartridge also has a male Luer fitting 216 on each end.

The receptacle has an upper and lower connectors 218, 220 that engages the respective ends of the cartridge. The upper and lower connectors have a female Luer connector coupled to a sleeve 222. The sleeve may be moved to engage the female Luer fitting of the sleeve with the male Luer fitting of the cartridge via operation of a lever 210, 214.

Upon insertion of the cartridge into the receptacle, a user grasps the lever 210 of the top connector of the receptacle above the cartridge and thrusts the lever downwards and to the left within slot 212. The lever and slot operate together to force the female Luer fitting downwards towards the cartridge and into the male Luer fitting while imparting a small twisting motion to the female Luer fitting. The downward motion of the female Luer fitting into the male Luer fitting and twisting motion causes the fittings to form a leakproof connection. The lower connector operates in substantially the same way via the user grasping the lever 214 and thrusting the lever upwards and to the right within the slot 216.

The cartridge may be fabricated of plastic. The cartridge may also have a radio frequency identification (RFID) label 224 attached to the side that engages the receptacle.

As the cartridge is inserted into the receptacle, the RFID label of the cartridge is brought into range of a RFID reader 226. The reader reads an identification code of the cartridge via the RFID label and transmits the identification code to the controller 34. A processor of the controller saves the identification code into a process file associated with the product made via the cartridge for tracking purposes.

In general, the system includes a cartridge assembly including a cartridge and receptacle, the cartridge containing a chromatographic material that captures one of a daughter and parent radionuclide from a mixture of the parent and daughter radionuclide passing longitudinally through the cartridge, the cartridge having respective transverse flanges on opposing ends, the receptacle having a slot on each end of a space that receives the cartridge where, the slots on each end receive the transverse flanges, the receptacle further including a connection assembly on each end of the space, the connection assemblies each having a lever that is moved along a respective slot that advances a connector towards the cartridge while twisting the connector as it makes contact with the cartridge to form a liquid tight connection.

Alternatively, the system includes a processing device for a radionuclide comprising. The processing devices further includes a housing, a cartridge containing a chromatographic material that captures one of a daughter and parent radionuclide from a mixture of a parent and daughter radionuclide flowing longitudinally through the cartridge, the cartridge having respective transverse flanges on opposing ends, a cartridge receptacle incorporated into the housing, the receptacle having a slot on opposing ends of the cartridge receptacle that receives the transverse flanges of the cartridge and a connection assembly of the cartridge receptacle on each end of the space, the connection assemblies each having a lever that is moved along a respective slot extending at least partially transverse to the longitudinal flow and that advances a connector towards the cartridge while twisting the connector as it makes contact with a respective connector of the cartridge to form a liquid tight connection.

A specific embodiment of method and apparatus for generating radionuclides has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A processing device for a radionuclide comprising:
a cartridge assembly including a cartridge and receptacle, the cartridge containing a chromatographic material that captures one of a daughter and parent radionuclide from a mixture of the parent and daughter radionuclide passing longitudinally through the cartridge, the cartridge having respective transverse flanges on opposing ends, the receptacle having a slot on each end of a space that receives the cartridge where, the slots on each end receive the transverse flanges, the receptacle further including a connection assembly on each end of the space, the connection assemblies each having a lever that is moved along a respective slot that advances a respective connector along an axis of engagement towards the cartridge while rotating the connector around the axis of engagement as it makes contact with the cartridge to form a liquid tight connection.

2. The cartridge assembly as in claim 1 further comprising a radio frequency identification (RFID) tag attached to the cartridge.

3. The cartridge assembly as in claim 1 wherein the connectors further comprising one of male and female Luer fittings.

4. The cartridge assembly as in claim 3 wherein the male and female Luer fitting further comprise male fitting attached to the cartridge.

5. The cartridge assembly as in claim 1 wherein the cartridge assembly further plastic.

6. The cartridge assembly as in claim 1 wherein the chromatographic material captures a daughter radionuclide.

7. A processing device for a radionuclide comprising:
a housing;
a cartridge containing a chromatographic material that captures one of a daughter and parent radionuclide from a mixture of a parent and daughter radionuclide flowing longitudinally through the cartridge, the cartridge having respective transverse flanges on opposing ends;
a cartridge receptacle incorporated into the housing, the receptacle having a slot on opposing ends of the cartridge receptacle that receives the transverse flanges of the cartridge; and
a connection assembly of the cartridge receptacle on each end of the space, the connection assemblies each having a lever that is moved along a respective slot extending at least partially transverse to the longitudinal flow and that advances a connector towards the cartridge while twisting the connector as it makes contact with a respective connector of the cartridge to form a liquid tight connection.

8. The cartridge assembly as in claim 7 further comprising a radio frequency identification (RFID) tag attached to the cartridge.

9. The cartridge assembly as in claim 7 wherein the connectors further comprising Luer fittings.

10. The cartridge assembly as in claim 9 wherein the Luer fittings further comprise male fittings extending from opposing ends of the cartridge.

11. The cartridge assembly as in claim 7 wherein the cartridge assembly further plastic.

12. The cartridge assembly as in claim 7 wherein the chromatographic material captures a daughter radionuclide.

13. A processing device for a radionuclide comprising:
a housing;
a container holding a parent radionuclide that decays into a daughter radionuclide;
a cartridge containing a chromatographic material that captures one of the daughter and parent radionuclide from a mixture of a parent and daughter radionuclide flowing longitudinally through the cartridge, the cartridge having respective transverse flanges on opposing ends and respective connectors extending through the transverse flanges;
a cartridge receptacle incorporated into the housing, the receptacle having a slot on opposing ends of the cartridge receptacle that receives the transverse flanges of the cartridge; and
a connection assembly of the cartridge receptacle on each end of the space, the connection assemblies each having a lever that is moved along a respective slot extending at least partially parallel and partially transverse to the longitudinal flow and that advances a connector in the longitudinal direction towards the cartridge while rotating the connector around the longitudinal direction as it makes contact with a respective connector of the cartridge to form a liquid tight connection.
